(19) United States
(12) Patent Application Publication
(10) Pub. No.: US 2014/0354934 A1
(43) Pub. Date: Dec. 4, 2014

(54) DISPLAY DEVICE AND METHOD FOR MANUFACTURING THE DISPLAY DEVICE

(71) Applicant: SHENZHEN CHINA STAR OPTOELECTRONICS TECHNOLOGY CO., LTD, Shenzhen (CN)

(72) Inventors: Xiaoyu Huang, Shenzhen (CN); Dongsheng Guo, Shenzhen (CN)

(73) Assignee: SHENZHEN CHINA STAR OPTOELECTRONICS TECHNOLOGY CO., LTD, Shenzhen (CN)

(21) Appl. No.: 14/001,504

(22) PCT Filed: Jun. 28, 2013
(86) PCT No.: PCT/CN2013/078315

§ 371 Date: Aug. 24, 2013

(30) Foreign Application Priority Data
May 28, 2013 (CN) 201310203885.0

(51) Int. Cl. G02F 1/1362; G02F 1/1333

(52) U.S. Cl. CPC G02F 1/136286; G02F 1/133305
USPC 349/139; 445/24

(57) ABSTRACT

A display device includes a display panel, a fan out area arranged at an edge of the display panel, a plurality of gate chip on films (G-COFs) are bonded on the edge of the display panel. The plurality of G-COFs are electrically connected with each other through the transmission circuit line, and at least one part of the transmission circuit line among the G-COFs is arranged on an external circuit board of the display panel.

### TECHNICAL FIELD

The present disclosure relates to a display field, and more particularly to a display device, and a method for manufacturing the display device.

### BACKGROUND

A thin film transistor liquid crystal display (TFT-LCD) is one of several typical main panel displays, and is an important display platform for modern information technology (IT) and video products.

As shown in FIG. 1, a TFT-LCD device of a chip on film (COF) includes a liquid crystal display (LCD) panel 100, a fan out area 101, a driving printed circuit board (PCB) 102, a source chip on film (S-COF) 103, and a gate chip on film (G-COF) 104. A motherboard of the TFT-LCD device is connected with a connector of the driving PCB through wiring lines and sends a red-green-blue compressing signal, a control signal, and a power to the driving PCB 102. The driving PCB 102 is connected with the LCD panel 100 through the S-COF 103 and the G-COF 104, which allows the LCD panel 100 to receive the power and signal, which are required by the LCD panel 100.

As shown in FIG. 2, a transmission cabling 111 is arranged at the fan out area 101 of the display panel, and an analog voltage and the control signal required by the G-COF 104 are transferred through the transmission cabling 111. As size of the TFT-LCD device increases, length of the transmission cabling 111 of the display panel 100 correspondingly increases, thus resistance value of a resistor R (R is resistor of the transmission cabling 111 in FIG. 2) of the transmission cabling 111 of the display panel 100 correspondingly increases, which causes different areas corresponding to the G-COFs to have different charging capacities, thereby causing defective horizontal blocks (H-blocks), as shown in FIG. 3. Namely the G-COFs corresponding to different display panel blocks have different charging capacities, the display panel blocks, which corresponds to the G-COFs 104 having low charging capacity, display abnormally. Thus, the above-mentioned problem needs to be solved.

### SUMMARY

In view of the above-described problem, the aim of the present disclosure is to provide a display device and a method for manufacturing the display device capable of uniform display of display panel blocks of the display device.

The purpose of the present disclosure is achieved by the following technical schemes:

A display device comprises a display panel, a fan out area arranged at an edge of the display panel, a plurality of gate chip on films (G-COFs) bonded on the edge of the display panel, and a transmission circuit line. The G-COFs are electrically connected with each other through the transmission circuit line, and at least one part of the transmission circuit line among the G-COFs is arranged on an external circuit board of the display panel.

Furthermore, the transmission circuit line comprises a first section circuit line etched in the fan out area of the display panel and a second section circuit line arranged on the external circuit board.

Furthermore, the external circuit board is a flexible circuit board, and a guide line of an inside of the flexible circuit board is regarded as the second section circuit line. Material and structure of the flexible circuit board are substantially same as material and structure of the G-COFs, difference between the flexible circuit board and the G-COFs is whether the IC is arranged. The flexible circuit board and the G-COFs are called the COF. Thus, in a manufacturing process of the display device, a process of bonding the flexible circuit board 120 is same as a process of bonding the G-COFs, in both processes, there is need to clean, attach an anisotropic conductive film (ACF) and a chip on film (COF), and press the COF. Therefore, the flexible circuit board and the G-COFs are simultaneously bonded on the LCD panel, which avoids adding a new technological process and reduces cost of production.

Furthermore, the flexible circuit board is arranged between every two of the G-COFs, which reduces impedance of the transmission circuit line between every two of the G-COFs, thereby avoiding abnormal display of display panel blocks corresponding to an area between every two of the G-COFs.

Furthermore, an anisotropic conductive film (ACF) is arranged on the flexible circuit board, the guide line of the inside of the flexible circuit board is electrically connected with a transmission cabling of the display device through conducting particle of the ACF, which conveniently allows the transmission cabling of the display panel to connect electrically.

A method for manufacturing a display device, comprises:

A: setting a preset circuit line at a fan out area of a display panel; and

B: bonding gate chip on films (G-COFs) and an external circuit board on an edge of the display panel, the external circuit board is regarded as a transmission circuit line among the G-COFs, in the step B, the G-COFs and the external circuit board is electrically connected with the preset circuit line of the display panel.

Furthermore, in the step B, the transmission circuit line comprises a first section circuit line etched in the fan out area of the display panel and a second section circuit line arranged on the external circuit board, where the first section circuit line is the preset circuit line and the second section circuit line is a guide line of inside of the external circuit board.

Furthermore, in the step B, the external circuit board is a flexible circuit board. Material and structure of the flexible circuit board are substantially same as material and structure of the G-COFs. The flexible circuit board and the G-COFs, are simultaneously bonded the display panel.

Furthermore, a flexible circuit board is arranged between every two of the G-COFS.

Furthermore, an anisotropic conductive film (ACF) is arranged on a flexible circuit board, a guide line of an inside of the flexible circuit board is electrically connected with a transmission cabling of the display device through conducting particles of the ACF.

In the present disclosure, at least one external circuit board is arranged among the G-COFs, where the guide line of the inside of the external circuit board is used to replace at least one part of the original transmission circuit line among the G-COFs. Due to internal impedance of the external circuit board being a lot less than impedance of the transmission cabling etched on the display panel, and even can be ignored, compared with a typical transmission circuit line, the present disclosure reduces impedance of an entire transmission circuit line. Thus, difference of charging capacities of the display panel blocks corresponding to the G-COFs is reduced, thereby avoiding abnormal display of the display panel blocks.

### BRIEF DESCRIPTION OF FIGURES

FIG. 1 is a structural diagram of a typical display device;

FIG. 2 is a schematic diagram of a transmission cabling among gate chip on films of a typical display device;

FIG. 3 is a schematic diagram of a abnormal display of display panel blocks of a typical display device;

FIG. 4 is a structural diagram of a display device of the present disclosure;

FIG. 5 is a first specific structural diagram of a display device having a flexible circuit board arranged among gate chip on films of the present disclosure; and

FIG. 6 is a second specific structural diagram a display device having a flexible circuit board among gate chip on films of the present disclosure.

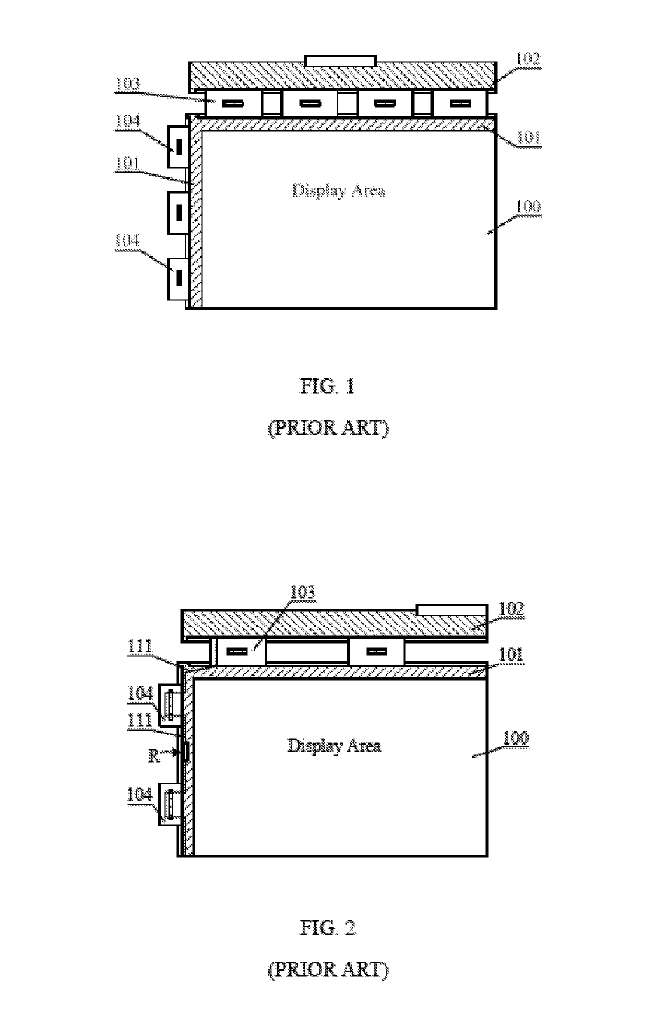

### DETAILED DESCRIPTION

The present disclosure will further be described in detail in accordance with the figures and the exemplary examples.

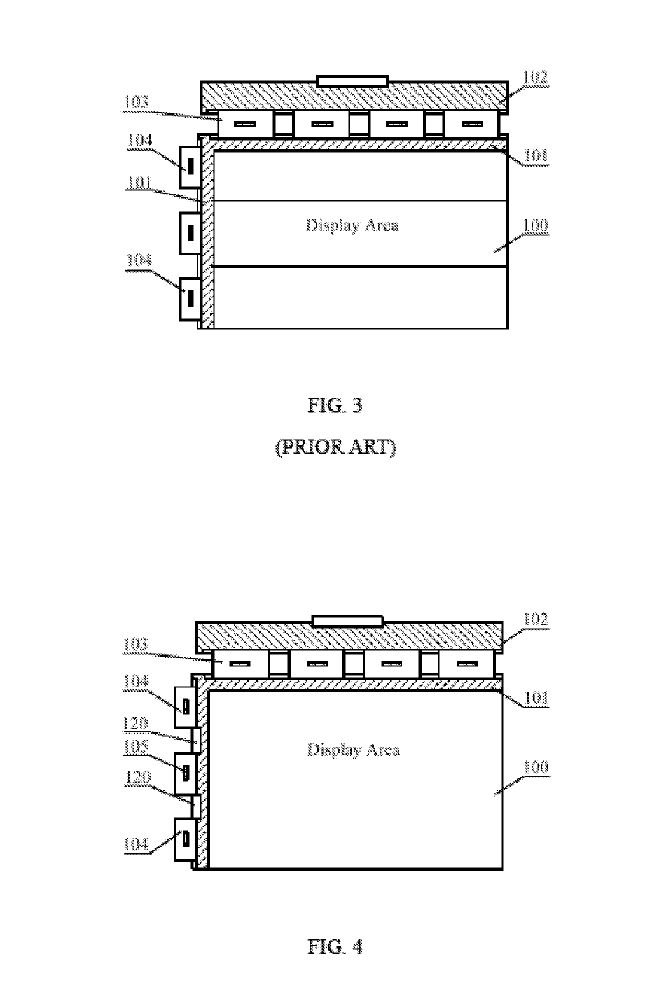

As shown in FIG. 4 to FIG. 6, the present disclosure provides a specific example, the example takes a thin film transistor liquid crystal display (TFT-LCD) for example. The TFT-LCD device comprises a liquid crystal display (LCD) panel 100, a fan out area 101 arranged at an edge area of the LCD panel 100, a driving printed circuit board (PCB) 102 arranged at one edge of the LCD panel 100, a source chip on film (S-COF) 103, and a gate chip on film (G-COF) 104. The driving PCB 102 is connected with the LCD panel 100 through the S-COF 103 and the G-COF 104, and the S-COF 103 and the G-COF 104 are arranged on the edge of the LCD panel 100. A motherboard of the TFT-LCD device is connected with a connector of the driving PCB through wiring lines, where the motherboard of the TFT-LCD device sends a red-green-blue compressing signal, a control signal, and a power to the driving PCB 102 when the TFT-LCD device is in operation. The driving PCB 102 sends the power and signal to the LCD panel 100 through the S-COF 103 and the G-COF 104, which allows the LCD panel 100 to receive the power and signal required.

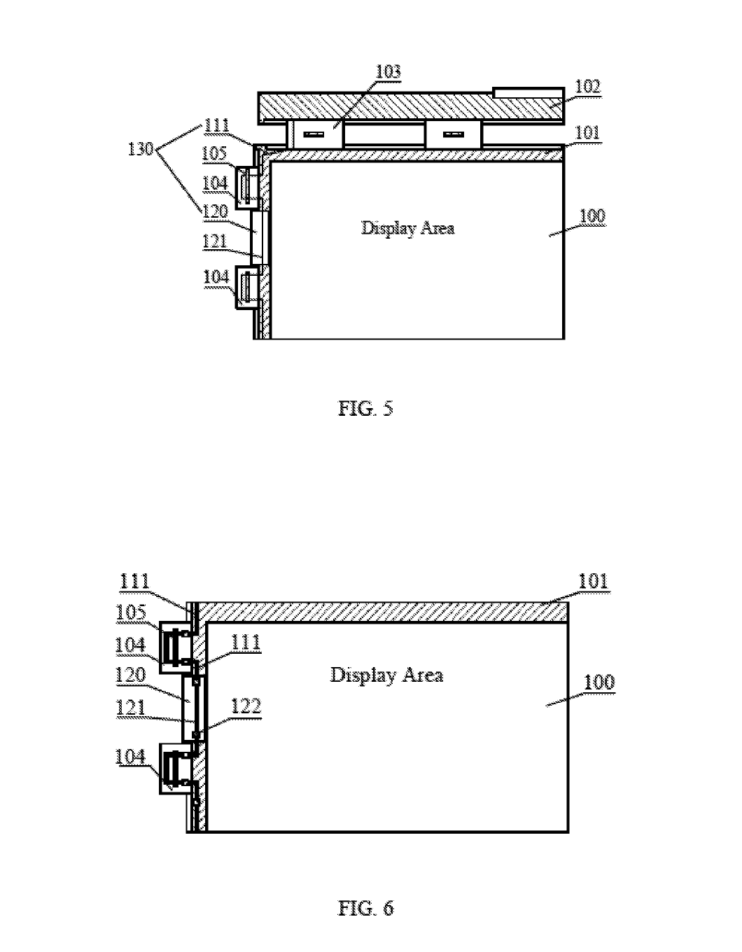

A transmission cabling 111 is arranged in the fan out area 101 and is etched on the LCD panel 100. A flexible circuit board 120 is arranged between every two G-COFs, where an integrated chip (IC) 105 is arranged in the G-COFs, and the IC is not arranged on the flexible circuit board. The flexible circuit board also is known as a chip on film, and is a chip on film which is not configured with the IC. Material and structure of the flexible circuit board are substantially same as material and structure of the G-COF, but difference between the flexible circuit board and the G-COF is whether the IC is arranged. The transmission cabling 111 is electrically connected with the flexible circuit board 120. As shown in FIG. 5 and FIG. 6, a transmission circuit line 130 is formed by the transmission cabling 111 and the flexible circuit board 120, where the G-COFs are electrically connected to each other through the transmission circuit line 130. The transmission cabling 111 etched on the LCD panel 100 is regarded as a first circuit line of the transmission circuit line 130, and the flexible circuit board 120 is regarded as a second section circuit line of the transmission circuit line 130, namely at least one part of the transmission circuit line 130 is arranged on the flexible circuit board 120 of the LCD panel 100, and the G-COFs is finally connected with the driving print circuit board 102 through the transmission circuit line 130.

In the example, internal impedance of the flexible circuit board 120 is very small and even can be ignored, and when the flexible circuit board 120 is used to replace the original transmission cabling 111 arranged in the fan out area 101 of the edge of the LCD panel 100, impedance of the wiring line is reduced. For example, impedance of guide line 121 of an inside of the flexible circuit board 120 is less than impedance of the transmission cabling 111, and the flexible circuit board 120 is used to reduce parasitic capacitance. Thus, an analog voltage and a control signal are transferred by the flexible circuit board 120, which reduces defective horizontal blocks (H-blocks) caused by the impedance.

In the example, material and structure of the flexible circuit board are substantially same as material and structure of the G-COFs, difference between the flexible circuit board and the G-COFs is whether the IC is arranged. Thus, in a manufacturing process of the TFT-LCD device, a process of bonding the flexible circuit board 120 is same as a process of bonding the G-COFs, in both processes, there is a need to clean, attach an anisotropic conductive film (ACF) and a chip on film (COF), and press the COF. Therefore, the flexible circuit board and the G-COFs are simultaneously bonded on the LCD panel, which avoids new technological process and reduces cost of production.

In the example, other circuit board also can replace the flexible circuit board 120, such as a common PCB, an integrated circuit board. When the common PCB or the integrated circuit board is used to replace the flexible circuit board of the present disclosure, an additional manufacturing process is correspondingly used, which improves costs by being compared with the flexible circuit board of the present disclosure.

In the example, the flexible circuit board 120 has no IC, which allows for an increase a width of the guide line of the inside of the flexible circuit board 120, and the width of the guide line of the inside of the flexible circuit board 120 may be greater than a width of a guide line of an inside of the G-COFs, thereby reducing impedance..

The present disclosure provides a method for manufacturing the TFT-LCD device. Except for processing step being relative to the transmission circuit line 130, other processing steps of the example and the typical TFT-LCD device are same, thus, it needs no repeated description.

As shown in FIG. 4 to FIG. 6, the method for manufacturing the TFT-LCD device comprises:

A: setting a preset circuit line (namely the transmission cabling 111) at the fan out area 101 of the LCD panel 100; and

B: bonding the G-COFs 104 and the flexible circuit board 120 on the edge of the LCD panel 100. In the step B, the G-COFs 104 and the flexible circuit board 120 are electrically connected with the preset circuit line of the LCD panel 100.

The transmission cabling 111 of the LCD panel 100 is regarded as the first section circuit line of the transmission circuit line 130, and the guide line of the inside of the flexible circuit board 120 is regarded as the second section circuit line of the transmission circuit line 130.

In the example, material and structure of the flexible circuit board are substantially same as material and structure of the G-COF, and the difference between the flexible circuit board and the G-COF is whether the IC is arranged. Thus, the process of bonding the flexible circuit board 120 and the G-COFs need to attach the ACF, attach the COF, and press the COF, which allows the ACF to be arranged on the flexible circuit board 120. The guide line of the inside of the flexible circuit board 120 is electrically connected with the transmission cabling 111 at a COF lead 122 through conducting particle of the ACF.

In the step B, the flexible circuit board 120 is arranged between every two G-COFs. A part of the transmission circuit line 111 between every two G-COFs is arranged on the flexible circuit board 120 (namely the guide line 121), and other part of the transmission circuit line is arranged on the fan out area 101 of the LCD panel 100 (namely the transmission cabling 111). The width of the guide line of the inside of the flexible circuit board 120 is greater than the width of the guide line of the inside of the G-COFs.

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A display device comprising:
a display panel;
a fan out area arranged at an edge of the display panel;
a plurality of gate chip on films (G-COFs) bonded on the edge of the display panel; and
a transmission circuit line;
wherein the G-COFs are electrically connected with each other through the transmission circuit line; at least one part of the transmission circuit line among the G-COFs is arranged on an external circuit board of the display panel.

2. The display device of claim 1, wherein the transmission circuit line comprises a first section circuit line etched in the fan out area of the display panel and a second section circuit line arranged on the external circuit board.

3. The display device of claim 2, wherein the external circuit board is a flexible circuit board, and a guide line of an inside of the flexible circuit board is regarded as the second section circuit line.

4. The display device of claim 3, wherein the flexible circuit board is arranged between every two of the G-COFs.

5. The display device of claim 3, wherein an anisotropic conductive film (ACF) is arranged on the flexible circuit board; the guide line of the inside of the flexible circuit board is electrically connected with a transmission cabling of the display device through conducting particle of the ACF.

6. A method for manufacturing the display device of claim 1, comprising:
A: setting a preset circuit line at a fan out area of a display panel; and
B: bonding gate chip on films (G-COFs) and an external circuit board on an edge of the display panel, the external circuit board is regarded as a transmission circuit line among the G-COFs, where the G-COFs and the external circuit board are electrically connected with the preset circuit line of the LCD panel.

7. The method for manufacturing the display device of claim 6, in the step B, the transmission circuit line comprises a first section circuit line etched in the fan out area of the display panel and a second section circuit line arranged on the external circuit board; the first section circuit line is the preset circuit line and the second section circuit line is a guide line on an inside of the external circuit board.

8. The method for manufacturing the display device of claim 7, wherein in the step B, the external circuit board is a flexible circuit board; material and structure of the flexible circuit board are substantially same as material and structure of the G-COFs; the flexible circuit board and the G-COFs are simultaneously bonded on the display panel.

9. The method for manufacturing the display device of claim 7, wherein a flexible circuit board is arranged between every two of the G-COFs.

10. The method for manufacturing the display device of claim 7, wherein an anisotropic conductive film (ACF) is arranged on a flexible circuit board, a guide line of an inside of the flexible circuit board is electrically connected with a transmission cabling of the display device through conducting particle of the ACF.
